(19) United States
(12) Patent Application Publication
(10) Pub. No.: US 2011/0005120 A1
(43) Pub. Date: Jan. 13, 2011

(54) Bow Fishing Rod

(75) Inventors: Petrus Theodorus de Koning, Toronto (CA); Ned Nenad Ivanovich, Brampton (CA); Robert Murray O'Brien, Ajax (CA); Jeffrey James LeBlanc, East Greenwich, RI (US)

Correspondence Address: COHEN, PONTANI, LIEBERMAN & PAVANE LLP, 551 FIFTH AVENUE, SUITE 1210, NEW YORK, NY, 10176, US

(73) Assignee: Spin Master Ltd.

(21) Appl. No.: 12/501,940

(22) Filed: Jul. 13, 2009

(51) Int. Cl. A01K 91/02

(52) U.S. Cl. 43/19

(57) ABSTRACT

The present application is directed to a fishing device comprising a body, a reel, an article of fishing tackle, fishing line attached to the reel and to the article of fishing tackle, and a spring-powered launch mechanism. The launch mechanism comprises a slidable member, in slidable relation with the body and adapted to releasably receive the article of fishing tackle, and at least one extension member which can be extended and subsequently released to impart a motive force on the slidable member and propel the article of fishing tackle from the fishing device.

### FIELD

The present invention relates to fishing devices, in particular fishing devices using an extension member to launch an article of fishing tackle or other projectile.

### BACKGROUND

Fishing is a popular sport and continues to grow in popularity as a sport and recreational activity. Different fishing styles and conditions require differing fishing equipment including different types of rods, reels, line, bait, lures, floats, sinkers, etc.

One of the most fundamental of all fishing techniques is that of “casting” a fastened bait or lure article into a desired location on the water. A person handling a rod-and-reel combination casts a bait using a rotational motion of the rod. In this manner, the rod is utilized to “throw” the bait in much the same way as an arm throws a ball or a stone. The rod starts in a tilted back position opposite the intended cast direction while the bait is typically pulled up and held near the rod tip. When the cast is started, the fishing line must be manually or mechanically fastened to the rod and reel so that the bait will properly follow the direction of the rod tip. As the rod is rotated forward, the relatively high velocity at the tip of the rod imparts a corresponding velocity on the bait which then travels in a direction and to a distance as determined by the force and direction applied in the rotation. Casting, along with other manual fishing techniques, often poses considerable challenges for younger, novice, or handicapped anglers.

A longtime favorite fishing setup that is particularly well-suited for younger or inexperienced anglers includes a so-called closed-face spincast reel together with a suitable rod. Spincast reels are well known to fishermen and are widely produced and readily available in most retail stores that carry fishing equipment and gear. By design, spincast reels provide for relatively simple line spooling and handling features, making them a popular choice for younger or less experienced anglers. Although spincast reels address many of the problems associated with line handling, the ability to accurately and safely cast fishing tackle having exposed hooks remains a barrier for many would-be anglers. The technique required for casting also poses substantial difficulties often to the extent that the individual simply cannot cast effectively and must rely on an experienced angler to perform the casting portion of the fishing experience.

Another problem occurs when fishing in close proximity to other people or near a structure that limits the possible range of motion during casting. Such situations may frequently arise, for example, on crowded boats, piers, and banks in which swinging fishing tackle having exposed hooks poses a significant hazard to oneself and/or nearby persons. In these situations, the ability to deliver a bait or lure to a desired location on the water is substantially limited by the mechanics of conventional manual casting techniques which require the angler to swing, sway, roll, flip, or otherwise move the end of the fishing rod or pole to effectuate a directed launching of the lure or bait.

It can therefore be appreciated that a need exists for an improved device and method for addressing the foregoing problems associated with casting fishing tackle easily, safely, and accurately. The bow fishing rod addresses such a need.

### SUMMARY

The present invention provides a fishing device which allows a user to launch an article of fishing tackle or other projectile using a launching mechanism powered by at least one extension member. In at least one embodiment the fishing device comprises a body adapted to be grasped by a user; a reel fixed to the body; an article of fishing tackle; fishing line, one end of which is attached to the reel and the other end of which is attached to the article of fishing tackle; and a launch mechanism. In at least one embodiment, the launch mechanism comprises a slidable member in slidable relation with the body, the slidable member being adapted to releasably receive the article of fishing tackle and having a slidable member handle adapted to be activated by a user. The launch mechanism further comprises at least one extension member each having a first end and a second end, the first end being fixed to the body and the second end being fixed to the slidable member. Activating the slidable member handle causes the at least one extension member to be extended and releasing the slidable member handle once the at least one extension member is extended allows the at least one extension member to contract and impart a motive force on the slidable member such that the article of fishing tackle is propelled from the fishing device. Once the article of fishing tackle is launched, it can be retrieved using the reel in a manner analogous to a standard fishing rod.

The present invention provides a fishing device from which an article of fishing tackle may be cast either using a conventional swing or arc casting technique or using a launching mechanism that is fun and reliable.

It is to be understood that other aspects of the present bow fishing rod will become readily apparent to those skilled in the art from the following detailed description, wherein various embodiments are shown and described by way of illustration. As will be realized, the bow fishing rod is capable of other and different embodiments and its several details are capable of modification in various other respects, all without departing from the spirit and scope of the bow fishing rod as described. Accordingly the drawings and detailed description are to be regarded as illustrative in nature and not as restrictive.

### BRIEF DESCRIPTION OF THE DRAWINGS

Preferred embodiments of the present invention will now be described in greater detail and will be better understood when read in conjunction with the following drawings in which:

FIG. 1 illustrates a rear perspective view of one embodiment of the present bow fishing rod;

FIG. 2 illustrates a side view of the embodiment of the bow fishing rod shown in FIG. 1;

FIG. 3 illustrates a partial side view of the embodiment of the bow fishing rod shown in FIG. 1, with part of the body removed to show the launch mechanism and locking mechanism;

FIG. 4 illustrates a front perspective view of one embodiment of the line release mechanism of the reel portion of the present bow fishing rod;

FIG. 5A illustrates a partial side perspective view of the line release mechanism shown in FIG. 4, with the catch pin extended;

FIG. 5B illustrates a partial side perspective view of the line release mechanism shown in FIG. 4, with the catch pin retracted;

FIG. 6A illustrates a front perspective view of one embodiment of the article of fishing tackle of the embodiment of the bow fishing rod shown in FIG. 1, in a closed position; and

FIG. 6B illustrates a front perspective view of one embodiment of the article of fishing tackle of the embodiment of the bow fishing rod shown in FIG. 1, in an opened position.

### DETAILED DESCRIPTION

The various features and components of the bow fishing rod are described with reference to the figures. While this invention is described in terms of one or more specific modes for achieving this invention's objectives, it will be appreciated by those skilled in the art that variations may be accomplished in view of these teachings without deviating from the spirit or scope of the present invention.

The present application is generally directed to an improved fishing apparatus, system and method that allows an angler to cast a fastened article of fishing tackle either using a conventional swing or arc casting technique or using a point-and-release casting method that eliminates problems encountered with swing or arc casting, enabling anglers to easily and safely cast in crowded spaces or limited-space environments such as when casting from under overhead manmade or natural obstructions such as power lines or tree branches. To this end, and as further depicted and explained with reference to the figures, the present bow fishing rod includes a casting mechanism that advantageously employs an extension member to provide a motive force to the article of fishing tackle. The article of fishing tackle may be a lure or bait or any other article or body or projectile that is attached to a fishing line and included among the material cast from the apparatus.

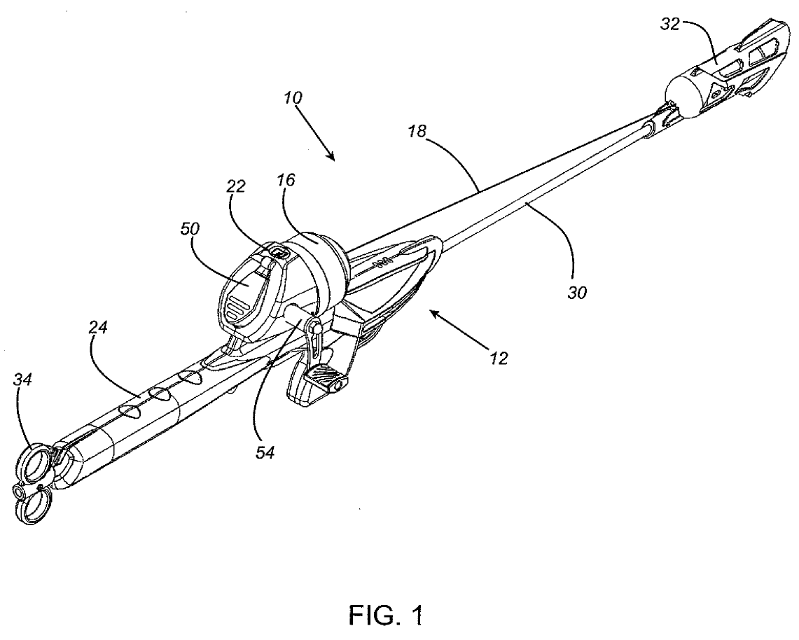

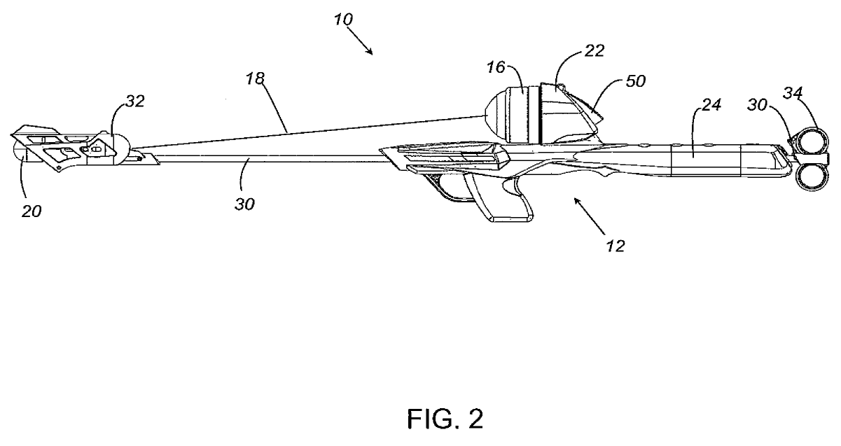

With reference to FIGS. 1, 2 and 3, in at least one embodiment the bow fishing rod 10 comprises a body portion 12, a launch mechanism 14, a reel 16 including a fishing line 18, and an article of fishing tackle 20. One end of fishing line 18 is attached to reel 16 and the other end is attached to article of fishing tackle 20 The body portion 12 acts to enclose and protect the interior components of the fishing device and to provide convenient gripping surfaces for a user so as to facilitate casting either using a conventional arc casting technique or a “bow” technique. Body portion 12 can be constructed by any method and in any material suitable to the application, including but not limited to plastic, fiberglass or graphite. In at least one embodiment, body portion 12 includes a reel housing 22 and a fishing handle 24 which is ergonomically formed for user comfort. It is contemplated that reel housing 22 and fishing handle 24 can be either integrally formed with body portion 12 or separate components from body portion 12 which are attached by means of adhesive, screws, pins, rivets, or any other suitable means known in the art. In embodiments that do not have reel housing 22, reel 16 can be attached to the body portion 12 using reel mounting methods well known in the art. For example, the reel can be attached to the body by fasteners including but not limited to adhesive, screws, pins, rivets, or other suitable fasteners. Alternatively, a standard quick connect receiver, or other tool-less mounting arrangements well-known to those skilled in the art can be used.

### Launch Mechanism

As seen in FIGS. 1, 2 and 3, in at least one embodiment the launch mechanism 14 includes a slidable member 30, which, in at least one embodiment, is a sensitive, flexible element which is not only instrumental in launching the article of fishing tackle from the device but also, once the article of fishing tackle is launched, provides “rod feel” and informs the user of the fishing device when he/she has a “bite” from a fish. In at least one embodiment, slidable member 30 is a rod formed from a strong, flexible material including but not limited to reinforced plastic, graphite or fiberglass, although other shapes and materials are also contemplated.

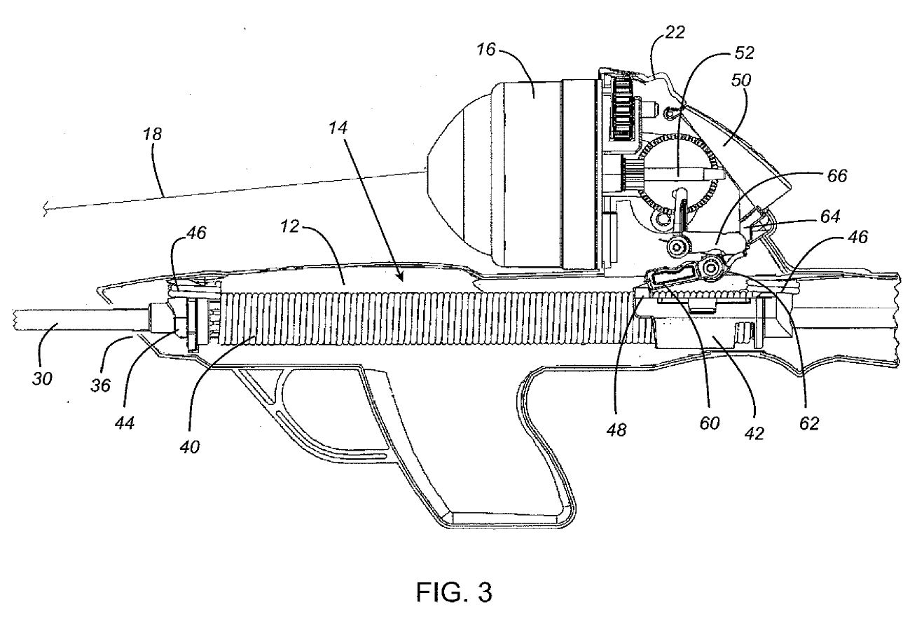

Projectile receptacle 32 is fixed to a receptacle end of slidable member 30 by any known means in the art, such as adhesive, screws, pins, rivets, or force fitting, and is adapted to releasably receive article of fishing tackle 20. Fishing line 18 passes through projectile receptacle 32 close to the receptacle end of slidable member 30, to provide contact between fishing line 18 and the receptacle end of slidable member 30, so that slidable member 30 can provide the “rod feel” described above. Slidable member handle 34 is fixed to a handle end of slidable member 30 by any known means in the art, such as adhesive, screws, pins, rivets, or force fitting. Either or both of slidable member handle 34 and projectile receptacle 32 can also be integrally formed with slidable member 30. It is contemplated that slidable member handle 34 can be mounted in different positions on slidable member 30, provided that slidable member handle 34 allows the launch mechanism 14 to be activated when the receptacle end is held pointing away from the user. Slidable member handle 34 and projectile receptacle 32 are typically formed of plastic, although other materials such as graphite, fiberglass and aluminum are also contemplated. In at least one embodiment, slidable member 30 is slidably retained within a channel 36 in body portion 12, as shown in FIG. 3.

In at least one embodiment, launch mechanism 14 includes at least one elastic extension member which provides a force to launch the article of fishing tackle from the device. In at least one embodiment, the extension member is an extension spring, although other types of extension members, including but not limited to elastic bands or surgical tubing, are also contemplated. The at least one extension member is aligned parallel to, or at an acute angle relative to, the slidable member, thereby also having a receptacle end, which is attached to the body, and a handle end, which is attached to the slidable member. The slidable member can be aligned coaxially with the extension member. Alternatively, two or more extension members may each be located next to and parallel to, or at an acute angle relative to, the slidable member, such that the extension members provide force on more than one side of launch mechanism resulting in smooth and balanced operation. When the two or more extension members comprise an elastic band or surgical tubing, it is contemplated that the handle ends of the extension members can be unitary with each other, such that both ends of a unitary elastic band or tubing are attached to the body to form a receptacle end, and the unitary elastic band or tubing is attached to the slidable member to form a handle end by methods including but not limited to passing around a projection or notch on, or through an opening in, the slidable member.

With reference to FIG. 3, in at least one embodiment, slidable member 30 passes through the central bore of extension spring 40. Extension spring 40 can be formed of any metal having suitable properties for a spring in this application. The handle end of extension spring 40 is fixed to spring mount 42 and the receptacle end of extension spring 40 is fixed to spring anchor 44, advantageously by means of eyes 46 on extension spring 40, although any attachment means known in the art are contemplated.

In at least one embodiment, spring mount 42 is fixed to slidable member 30 at a position between the receptacle end and the handle ends depending on the final dimensions of the bow fishing rod 10. Spring mount 42 is typically formed of plastic, although other materials such as graphite, fiberglass and aluminum are also contemplated. Spring mount 42 is fixed to slidable member 30 by any known means in the art, such as adhesive, screws, pins, rivets, or force fitting, or can be integrally formed with slidable member 30. Spring mount 42 is configured such that it can receive the handle end of extension spring 40, for example by engaging eye 46. Spring mount 42 further includes a ridge 48 which engages pawl 60 when the launch mechanism is in the locked position, as will be described in further detail below.

In at least one embodiment, spring anchor 44 is adapted to receive the receptacle end of extension spring 40, for example by engaging eye 46. Spring anchor 44 is formed of plastic or any other suitable material and is fixed to, or integrally formed with, body portion 12, as illustrated in FIG. 3. In at least one embodiment, spring anchor 44 also contains a bore wherein slidable member 30 of launch mechanism 14 is slidably retained. A guide bushing (not shown) is also provided at the handle end of body portion 12 to slidably receive slidable member 30. Therefore, slidable member 30 makes frictional contact only at the sliding interfaces with spring anchor 44 at the receptacle end and the guide bushing at the handle end of the bow fishing rod 10.

### Reel

In at least one embodiment body portion 12 includes a reel housing 22 which is adapted to receive a reel 16. Reel 16 is typically a closed face spincast fishing reel, however it is contemplated that an open faced or spinning type reel may be used. In embodiments that do not have reel housing 22, reel 16 can be a standard aftermarket reel which can be attached to the body portion using reel mounting methods well known in the art. For example, the reel can be attached to the body by fasteners including but not limited to adhesive, screws, pins, rivets, or other suitable fasteners. In addition, a standard quick connect receiver, or other tool-less mounting arrangements well-known to those skilled in the art can be used. Alternatively, as illustrated in FIGS. 1, 2 and 3, reel 16 is specifically designed to fit within reel housing 22.

Reel 16 is equipped with fishing line 18 and is adapted to release the line in preparation for launching the article of fishing tackle 20 and to retrieve the line following launch. Reel 16 is equipped with a line release mechanism which is activated when line release trigger 50 is depressed, urging line release shaft 52 towards reel 16, as is described in further detail below. This feature allows fishing line 18 to freely unwind from reel 16 when the article of fishing tackle 20 is cast, ensuring that the farthest possible cast distance is achieved. Retrieval is typically achieved by way of a hand crank 54 (FIG. 1), rotation of which acts to reset the line release mechanism so that the reel 16 engages fishing line 18, as is described below.

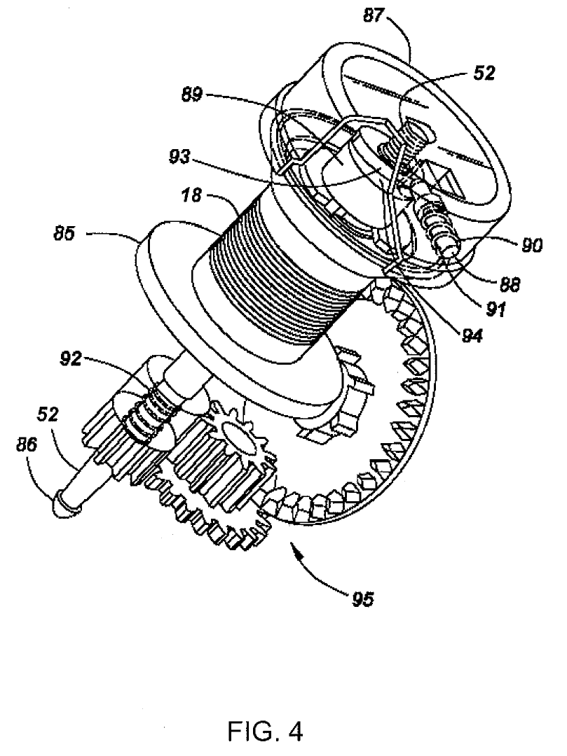

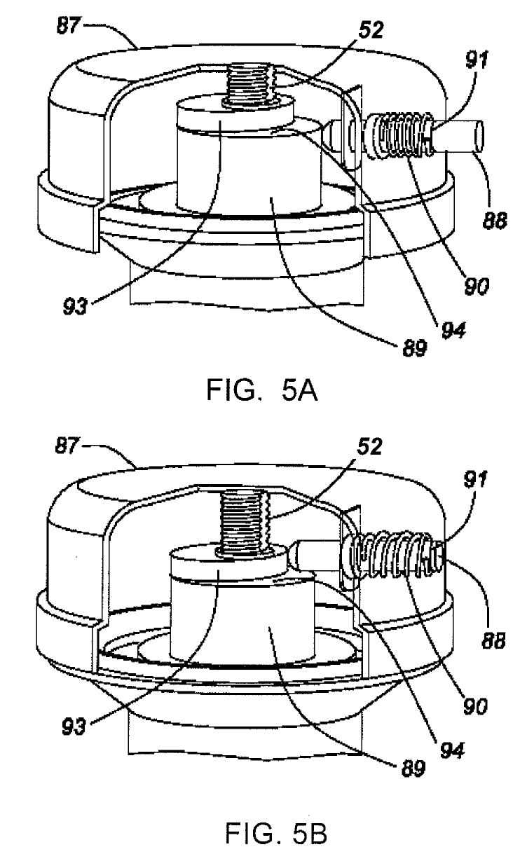

Referring to FIGS. 4, 5A and 5B, the line release mechanism includes release shaft 52, which is D-shaped in cross-section and which passes through a circular bore in spool 85, through which shaft 52 can be freely rotated. Release shaft 52 has release tip 86 at one end and is attached to spool cover 87 at the other end. As shown in FIG. 5A, when the reel assembly is engaged, line catch pin 88 is urged by shoulder 89, against the bias of compression spring 90, through an opening 91 in spool cover 87, and engages fishing line 18 (not shown). As shown in FIGS. 3 and 5B, when line release trigger 50 is depressed by an operator, it contacts release tip 86, urging release shaft 52 and attached spool cover 87, against the bias of compression spring 92, away from spool 85. Line catch pin 88 is urged against shoulder 93 by compression spring 90 and retained by lip 94 against the bias of compression spring 92, so that line catch pin line release trigger 50 no longer protrudes through opening 91, releasing fishing line 18 and allowing it to pass freely from spool 85. When hand crank 54 (FIG. 1) is operated, release shaft 52 and attached spool cap 87 are rotated through the interaction of gear train 95, and line catch pin 88 travels along lip 94, being gradually urged outwards by shoulder 93 against the bias of spring 90. When line catch pin 88 has traveled to the point where shoulder 93 is flush with shoulder 89, so that lip 94 no longer retains line catch pin 88, release shaft 52 and spool cover 87 are urged back towards spool 85 by compression spring 92. Shoulder 89 again urges line catch pin 88 through opening 91, so as to again engage fishing line 18, allowing the operator to reel in a fish.

### Locking Mechanism

In at least one embodiment, the present bow fishing rod 10 further includes a locking mechanism so that extension spring 40 cannot be extended to launch article of fishing tackle 20 until the line release mechanism of reel 16 is activated, as described above. This provides an added feature for novice users, or those with less manual dexterity, and ensures that when the article of fishing tackle 20 is launched, the fishing line is already free to unreel with negligible force so that the farthest possible cast distance is achieved. Referring to FIG. 3, the locking mechanism comprises pawl 60 which is pivotally mounted on body portion 12 and is biased by torsion spring 62 to engage ridge 48 on spring mount 42, preventing slidable member 30 from being moved in the direction of its handle end. When line release trigger 50 is depressed to activate the line release mechanism as described above, projection 64 on release trigger 50 acts to pivot pawl 60 so that it releases ridge 48, allowing slidable member 30 to be moved in the direction of its handle end so as to extend extension spring 40 and launch article of fishing tackle 20. When hand crank 54 is rotated so as to retrieve fishing line 18, release shaft 52 moves as described above to urge line release trigger 50 and projection 64 to their position prior to being depressed by a user, and lever 66 and torsion spring 62 act to reset the pawl 60 so that it again engages ridge 48 on spring mount 42.

### Article of Fishing Tackle

The purpose of the article of fishing tackle or bobber 20 is to carry the tackle, that is, the bait and hook to catch a fish. The article of fishing tackle 20 is similar to that described in U.S. Pat. No. 6,880,286, which is herein incorporated by reference. The present self-propelled cast fishing system is described as being capable of launching an article of fishing tackle 20, however, those skilled in the art will appreciate that other suitable projectiles can be launched as well. For example, one could contemplate launching a “hook hiding lure”, or other mechanism to attract or catch fish.

Article of fishing tackle 20 is aerodynamically shaped and is designed to fit inside projectile receptacle 32. In addition, the article of fishing tackle 20 also encloses the hook and bait, thus addressing the disadvantage of conventional bobber configurations wherein the range of casting motion is substantially restricted by the danger of the exposed hook.

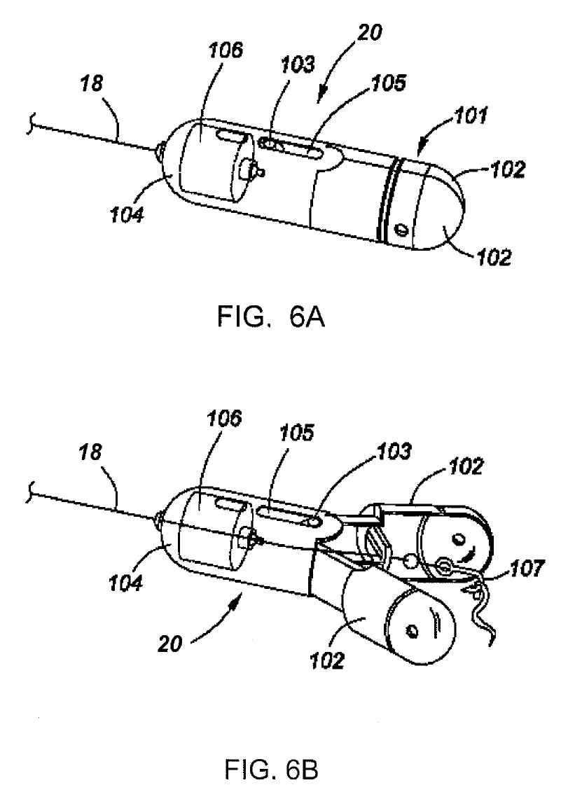

Referring to FIGS. 6A and 6B, in at least one embodiment, the distal half 101 of the article of fishing tackle 20 is a “split clamshell” arrangement. Clamshell sides 102 can be opened and closed by rotation about pivot pin 103 and, in the closed state, distal half 101 can be recessed into the proximal half 104 of the article of fishing tackle 20 by sliding pivot pin 103 inwards in slot 105, so as to prevent clamshell sides 102 from opening. In operation, when the article of fishing tackle 20 hits the water, the proximal half 104 floats on the surface, aided, for example, by a float 106 contained in proximal half 104. The weight of the distal half 101 and its contents, including, for example, tackle 107 and/or a weight (not shown) attached to one or both of clamshell sides 102 to aid the opening of distal half 101, causes pivot pin 103 to slide outwards in slot 105 under the force of gravity or of the motion of the article of fishing tackle 20, thereby allowing clamshell sides 102 to open, releasing tackle 107 attached to fishing line 18. If a weight is attached to one or both of clamshell sides 102, it is advantageously located in the portion closer to pivot pin 103, so as to maximize the opening of clamshell sides 102 upon entry into the water. Fishing line 18 can freely pass through an opening in proximal half 104, allowing the tackle 107 to move away from proximal half 104 so as to be freely available for ingestion by a fish.

### Operation

In operation, in at least one embodiment of the present bow fishing rod, a user depresses line release trigger 50 to activate the line release mechanism of reel 16 and to unlock slidable member 30 by releasing ridge 48 on spring mount 42 from engagement with pawl 60. The user then either casts article of fishing tackle 20 in a conventional arc and swing manner, or grasps slidable member handle 34 and pulls slidable member 30 back towards the user. This places increasing tension on the extension spring 40 by stretching it between its receptacle end which is fixed to spring anchor 44 and its handle end which is fixed to spring mount 42. When the user releases slidable member handle 34, the slidable member 30 will be quickly urged back in the direction of its receptacle end as extension spring 40 contracts. Once extension spring 40 has contracted fully, slidable member 30 will decelerate rapidly from a high velocity to a stationary position. The spring force imparted on slidable member 30 will be translated to the article of fishing tackle 20, launching it from projectile receptacle 32. Once the article of fishing tackle 20 is launched into a body of water, it can be retrieved by rewinding fishing line 18 for storage until the next launch using reel 16.

The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims.

1. A fishing device, the device comprising:
a body adapted to be grasped by a user;
a reel fixed to the body;
an article of fishing tackle;
fishing line having a reel end and a tackle end, the reel end being fixed to the reel and the tackle end being fixed to the article of fishing tackle; and
a launch mechanism comprising:
a slidable member in slidable relation with the body, the slidable member being adapted to releasably receive the article of fishing tackle and having a slidable member handle adapted to be activated by a user; and
at least one extension member each having a first end and a second end, the first end being fixed to the body and the second end being fixed to the slidable member, such that activating the slidable member handle causes the at least one extension member to be extended and releasing the slidable member handle once the at least one extension member is extended allows the at least one extension member to contract and impart a motive force on the slidable member such that the article of fishing tackle is propelled from the fishing device.

2. The fishing device according to claim 1 wherein the reel comprises a line release mechanism, the device further comprising a locking mechanism to prevent activation of the slidable member handle, such that when the line release mechanism is activated, the locking mechanism is released so as to allow activation of the slidable member handle.

3. The fishing device according to claim 2 wherein the locking mechanism comprises a pawl in releasable engagement with the launch mechanism, the pawl being moved out of engagement with the launch mechanism when the line release mechanism is activated.

4. The fishing device according to claim 1 wherein the slidable member is a flexible rod having a receptacle end adapted to releasably receive the article of fishing tackle and a handle end comprising the slidable member handle, wherein the receptacle end of the rod is in contact with the fishing line.

5. The fishing device according to claim 1 wherein the slidable member is coaxially aligned with the body.

6. The fishing device according to claim 1 wherein the slidable member is coaxially aligned with the at least one extension member.

7. The fishing device according to claim 1 wherein the at least one extension member is two or more extension members aligned parallel with or at an acute angle relative to the slidable member.

8. The fishing device according to claim 1 wherein the at least one extension member is at least one extension spring.

9. The fishing device according to claim 8 wherein the slidable member is coaxially aligned with the at least one extension spring.

10. The fishing device according to claim 1 wherein the at least one extension member is an elastic band or surgical tubing.
